(19) United States
(12) Patent Application Publication
(10) Pub. No.: US 2011/0043814 A1
(43) Pub. Date: Feb. 24, 2011

(54) ULTRA STABLE SHORT PULSE REMOTE SENSOR

(75) Inventors: Steve Ray Wilkinson, Stevenson Ranch, CA (US); Todd O. Clatterbuck, Playa Vista, CA (US); Thomas R. Nelson, Albuquerque, NM (US)

Correspondence Address: Pillsbury Winthrop Shaw Pittman LLP;(Raytheon SAS), P.O. Box 10500, McLean, VA, 22102, US

(73) Assignee: RAYTHEON COMPANY, Waltham, MA (US)

(21) Appl. No.: 12/546,371

(22) Filed: Aug. 24, 2009

(51) Int. Cl. G01B 9/02

(52) U.S. Cl. 356/450

(57) ABSTRACT

An ultra-stable short pulse remote sensor having extended temporal coherence for long range sensing. The sensor provides unique target signatures from an ultrashort pulse after it has interacted with a target at range by measuring the spectral amplitude and phase of the pulse. Accordingly, coherent detection of targets at long ranges can be performed with reduced power.

### GOVERNMENT RIGHTS

The U.S. Government may have certain rights in this application as provided for in Cooperative Research and Development Agreement (CRADA) no. 99-RMSC-MULT-1547 executed Jul. 31, 2003.

### BACKGROUND

Conventional pulsed laser remote sensors perform over short distances on the order of 1 km or less. Further, they typically require high power and implement incoherent direct detection methods. In contrast, conventional coherent pulsed laser sensors interfere a scattered pulse reflected from a target with a portion of the emitted pulse which was transmitted by the laser at an earlier time. A laser having extremely narrow frequency linewidths and a coherence length of at least twice as long as the operating range of the sensor must be used to ensure interference of the scattered pulse and the emitted pulse.

In order to use temporally short pulses for coherent detection, the center frequency of the laser must be stabilized to increase its coherence length. In practice, this is complex and difficult since free running ultrafast laser systems typically have a coherence length of a single pulse duration. Thus, conventional coherent pulsed laser sensors must use a delay line equal to the round trip time-of-flight because it is necessary to interfere the scattered pulse with the same emitted pulse which produced the scattered pulse.

As a result, a low power coherent pulsed laser remote sensor having a long coherence time is desired in order to sense targets at long ranges. Further, it is desired that the laser sensor utilize amplitude and phase information contained in radiation pulses scattered by the targets to determine unique target signatures.

### SUMMARY

According to various embodiments, an ultra-stable short pulse remote sensor having extended temporal coherence for long range environmental sensing, surveillance, and reconnaissance is disclosed. In particular, the sensor determines unique target signatures after an ultrashort pulse has interacted with a target at range by measuring the spectral amplitude and phase of the scattered pulse. As a result, the ultra-stable short pulse remote sensor improves over conventional optical remote sensors by achieving coherent detection of targets with reduced power and at long range, e.g., megameter ranges. Further, the ultra-stable short pulse sensor can be implemented in a small and lightweight system using commercially available technology.

In an embodiment, a receiver is configured to detect ultrashort multispectral pulses of radiation scattered by a target, the receiver comprising a detector configured to detect scattered radiation pulses produced by scattering of emitted radiation pulses by the target; an interferometer configured to interfere the scattered pulses with a reference pulse, wherein the emitted pulses and the reference pulse are different radiation pulses in a series of pulses; and a processor configured to determine an intensity and a phase of the scattered pulses based on the interference of the scattered pulses with the reference pulse.

In a further embodiment, a method of detecting ultrashort multispectral pulses of radiation scattered by a target includes generating a series of coherent radiation pulses; selecting reference radiation pulses from the series of pulses; emitting radiation pulses from the series of pulses, wherein the reference pulses and the emitted pulses are different pulses; receiving scattered radiation pulses produced by scattering of the emitted pulses by the target; interfering the scattered pulses with the reference pulses; and determining an intensity and a phase of the scattered pulses based on the interference.

In a further embodiment, a system is configured to emit and receive ultrashort multispectral pulses of radiation, the system comprising a source configured to generate a series of radiation pulses including reference radiation pulses and emitted radiation pulses produced by scattering of the emitted radiation pulses by a target; a receiver configured to receive scattered radiation pulses produced by scattering of the emitted radiation pulses by a target; an interferometer configured to interfere the scattered pulses with reference pulses; and a processor configured to determine an intensity and a phase of the scattered pulses based on an output of the interferometer.

These and other features and advantages of the novel and non-obvious system and method will be apparent from this disclosure. It is to be understood that the summary, drawing, and detailed description are not restrictive of the scope of the inventive concept described herein.

### BRIEF DESCRIPTION OF THE DRAWINGS

FIG. 1 shows the conceptual operation of the laser sensor;

FIG. 2 shows oscillator pulse trains comprising an example pulse n₀ and a second example pulse n₀+n;

FIG. 3 compares coherent and incoherent interferograms;

FIG. 4 shows the spectrogram of a conventional reference pulse as function of delay and wavelength (public domain information provided by Rick Terbino, Georgia Institute of Technology);

FIG. 5 shows the intensity and phase of the conventional reference pulse of FIG. 4 as a function of time (public domain information provided by Rick Terbino, Georgia Institute of Technology);

FIG. 6 shows experimental results of a conventional spectrum of an interferogram as a function of wavelength;

FIG. 7 shows a signature corresponding to a first target;

FIG. 8 shows a signature corresponding to a second target;

FIG. 9 shows an ultrastable short pulse remote sensor based on an ultrafast laser with extended temporal coherence according to an embodiment;

FIG. 10 shows an ultrafast laser source according to an embodiment;

FIG. 11A shows a conventional pulse train in the time-domain;

FIG. 11B shows the conventional pulse train having pulses with different phases;

FIG. 11C shows the conventional pulse train in the frequency domain;

FIG. 12 shows a conventional ultra-wideband supercontinuum pulse;

FIG. 13 shows a receiver according to an embodiment; and

FIG. 14 shows an interferogram.

### DETAILED DESCRIPTION

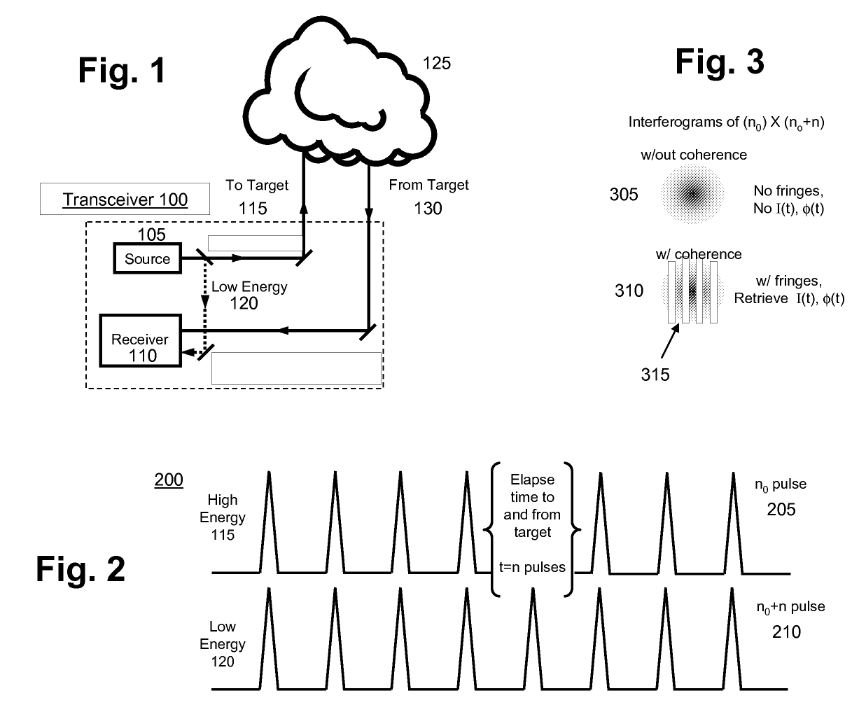

FIG. 1 shows an exemplary ultrafast laser transceiver 100 with extended temporal coherence. Transceiver 100 comprises temporally stabilized laser source 105 and receiver 110. Source 105 emits a radiation beam comprising a train of ultrafast source pulses at a well defined repetition frequency.

In an embodiment, the pulses emitted from source 105 are split into a beam of high-energy pulses 115 and a beam of low-energy reference pulses 120. High-energy pulses 115 are launched toward target 125 and interact with target 125. Scattered radiation pulses 130 are reflected back to receiver 110 due to scattering of high-energy pulses 115 by target 125.

Low-energy reference pulses 120 are coupled directly from source 105 to receiver 110. Receiver 110 coherently combines low-energy pulses 120 and scattered pulses 130 to produce a signal for output or further processing. In particular, the optical information contained in scattered pulses 130 may be measured by determining the differences between scattered pulses 130 and low-energy reference pulses 120. Such analysis of scattered pulses 130 permits, e.g., discovery, detection, recognition, and/or verification of target 125. The range of transceiver 100, however, may be limited due to instability of reference pulses 120 with respect to time, and the greater time-of-flight required for pulses 115 and 130 to reach more distant targets 125.

FIG. 2 shows exemplary pulse trains 200 for the beam of high-energy pulses 115 and the beam of low-energy reference pulses 120. While the sensor is not limited to single pulse detection, the discussion of the sensor operation may address two representative pulses for ease of

understanding. In particular, scattered pulses 130 comprises pulse n₀ 205 which has been time delayed relative to reference pulses 120. The time delay results due to the time-of-flight required for pulses 115 and 130 to reflect from target 125. Pulse n₀ 205 is caused to interfere with pulse n₀+n 210, which may be sampled directly from laser source 105 and provided by reference beam 120. In an embodiment, n is a large number of pulses emitted from source 105 during the time delay of pulse n₀ 205, e.g., tens, hundreds, thousands, or millions of pulses.

In one or more embodiments, a conventional delay line is not required. Conventional delay lines were necessary in previous devices due to the short coherence time of conventional laser sources which caused radiation pulses to lose coherency with subsequent pulses emitted after the coherence time. Therefore, without a conventional delay line, the coherency between a scattered pulse and a subsequent (i.e., reference) pulse would be lost by the time the scattered pulse returned from the target. As a result, conventional delay lines were provided to enable both scattered pulses 130 and the reference pulse 120 from the same source pulse 105 to be interfered. Accordingly, it was necessary to match the delay of the conventional delay line to the time-of-flight for a pulse to reach the target and to return from the target. In contrast, according to an embodiment, scattered pulse n₀ 205 can be interfered, e.g., with subsequent reference pulse n₀+n 210, since reference pulses 120 remain coherent for an extended period of time.

FIG. 3 shows the detecting of frequency information associated with scattered pulses 130 by non-linearly mixing scattered pulses 130 and reference pulses 120. In particular, interferograms 305 and 310 may be produced by interference between pulse n₀ 205 and pulse n₀+n 210 and contains the optical information of pulse n₀ 205. In order to produce a reliable signal, pulse n₀ 205 must be coherent with pulse n₀+n 210, such that the interferogram 310 is modulated with a wavelength dependant fringe pattern 315.

In contrast, if pulse n₀ 205 and pulse n₀+n 210 are not coherent, e.g., as in a free-running oscillator, no fringe pattern is observed, as shown by interferogram 305. Furthermore, it is not possible to detect and compensate for instantaneous intensity fluctuations in source 105. Therefore, intensity I(t) and phase φ(t) information cannot be determined. The length of time that pulse n₀ 205 can be coherently maintained with respect to pulse n₀+n 210 limits the range to which transceiver 100 can detect target 125. Typically, conventional ultrafast lasers which operate with high repetition rates in excess of tens of MHz have short temporal coherence.

However, it is possible to increase the range of transceiver 100 by increasing the temporal coherence of source 105 so that pulse n₀ 205 remains coherent with pulse n₀+n 210 over multiple pulses. In an embodiment, source 105 may have long term temporal stability in excess of 100 seconds. Further, such long term temporal stability enables interferogram 310 to use a multi-pulse exposure to improve the signal-to-noise ratio. For example, a one second exposure (i.e., only 1% of temporal coherence of source 105) allows interferogram 310 to be constructed from over a million pulses.

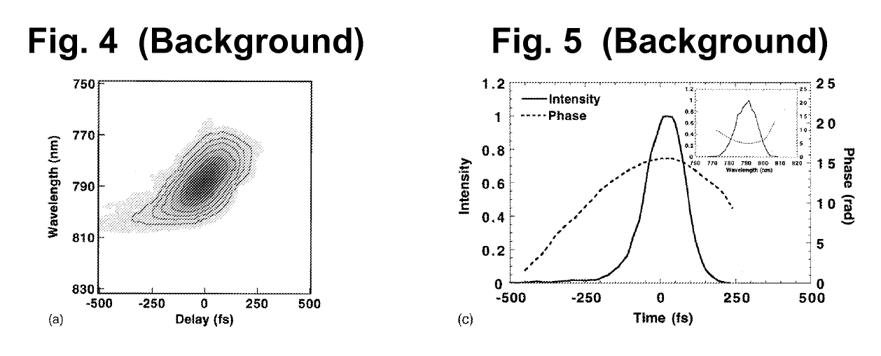

FIGS. 4 and 5 show alternative conventional characterizations of reference pulse 120. In particular, FIG. 4 shows the intensity of reference pulse 120 as a function of delay and wavelength. Further, FIG. 5 shows the intensity and phase of reference pulse 120 as a function of delay. By accurately characterizing reference pulse 120, it is possible to determine the signature of target 125 from scattered pulses 130. In an embodiment, target 125 can be classified and/or identified by comparing the target signature to a database of target signatures.

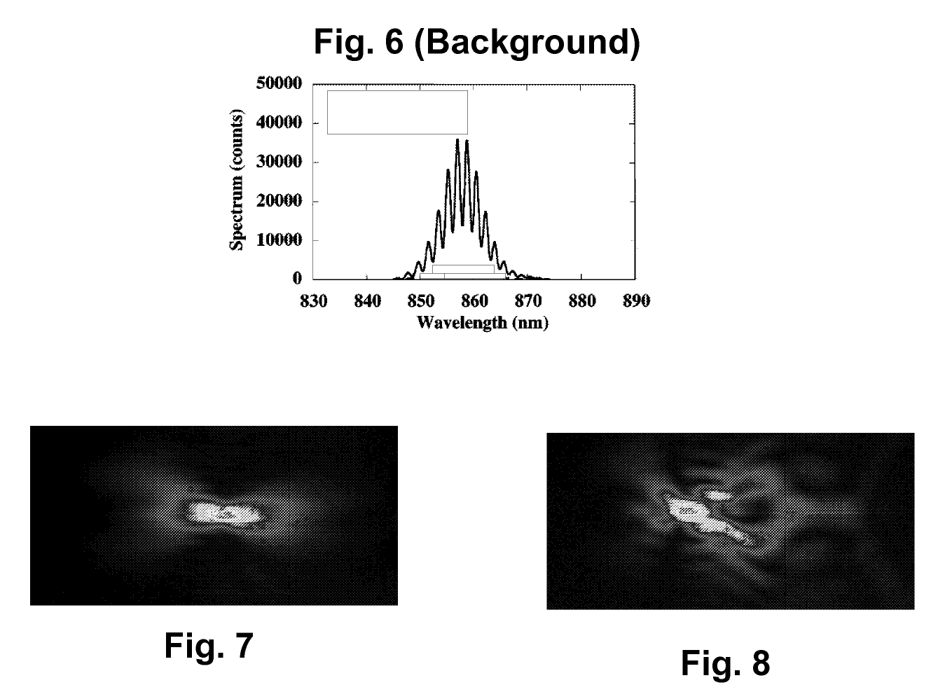

FIG. 6 shows the spectrum of exemplary interferogram 310 (see FIG. 3) produced by the interference of reference pulse 120 with scattered pulses 130. In particular, fringes 315 indicate the interference between reference pulse 120 with scattered pulses 130 caused by coherence between the pulses.

FIG. 7 shows an exemplary pulse spectrograph of a scattered pulse corresponding to a first target, i.e. a first mirror. Additionally, FIG. 8 shows an exemplary pulse spectrograph of a scattered pulse corresponding to a second target, i.e. a second mirror. As can be seen, each mirror interacts with the reference pulse in an unique manner, thus producing distinct signatures corresponding to a respective mirror.

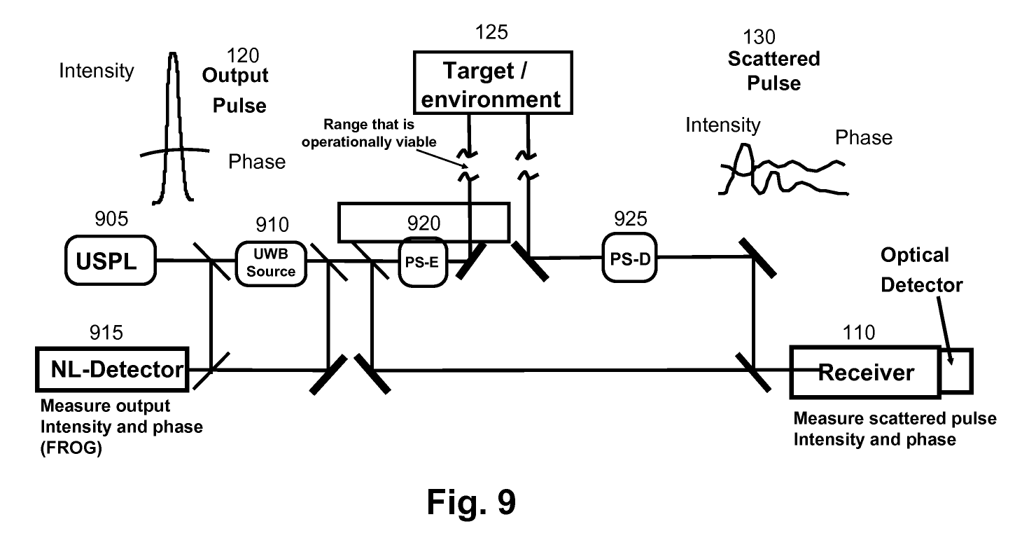

FIG. 9 shows a remote sensing system according to an embodiment. Ultra-stable pulse laser (USPL) 905 generates a pulse train of ultrashort laser pulses having a wavelength, e.g. between 400 nm and nm. In various embodiments, the pulse train can have a repetition rate on the order of 0.1 to 10 GHz, and the duration of each pulse can be on the order of several femtoseconds. Further, laser 905 is capable of extended temporal coherence such that the pulses in the pulse train are coherent with one another for an extended time period.

Ultra-wideband (UWB) source 910 converts the pulses produced by laser 905 to a supercontinuum of pulses having broad multispectral bandwidth, e.g. up to 500 THz. The pulses are characterized by non-linear (NL) detector 915 either before or after being provided to UWB source 910. An exemplary reference pulse 120 is shown having an intensity and phase which is representative of each of the other pulses in the pulse train.

Pulse shaping encoder (PS-E) 920 shapes the pulses for performance, e.g. in a military environment, and may have adaptive capabilities. In various embodiments, PS-E 920 can be configured as a liquid crystal spatial light modulator to adjust amplitude and phase of the individual spectral components. The pulses reflect from target 125 and pulse shaping decoder (PS-D) 925 recovers scattered pulses 130 from the signal received from target 125. The intensity and phase of an exemplary scattered pulses 130 are shown. Receiver 110 interferes reference pulse 120 with scattered pulses 130 in order to recover the signature of target 125.

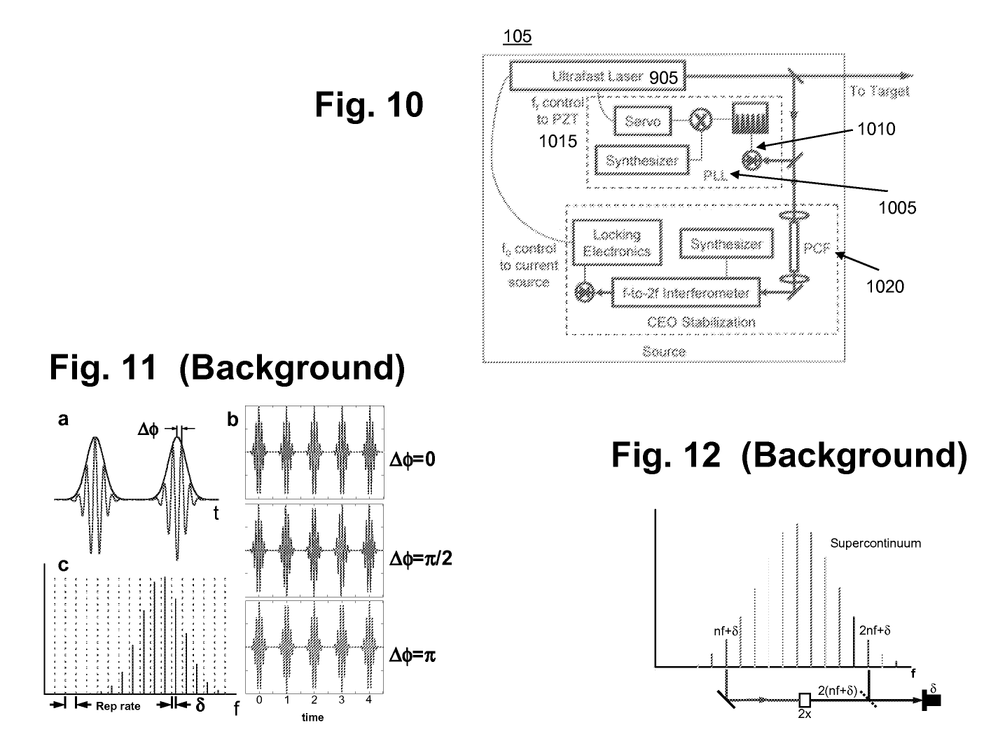

FIG. 10 shows laser source 105 according to an embodiment which comprises two stabilizing mechanisms. Source 105 comprises ultrashort pulsed or “ultrafast” laser (USPL) 905 with both repetition rate and carrier-envelop offset (CEO) stabilizations. One requirement of laser 905 comes from the CEO stabilization, which generally benefits from an octave of spectral width. This octave of spectral width can either be inherently designed into the laser or can be created through a process such as supercontinuum generation. Supercontinuum generation is a nonlinear phenomenon where the interaction of an ultrafast laser with, but not limited to, photonic crystal fiber (PCF) broadens the fundamental laser spectrum into a UWBW laser spectrum. If supercontinuum generation is used to meet the CEO stabilization criteria, the laser spectrum can be configured to be above 0.2 μm and below 2 μm.

In an embodiment, the repetition rate of laser 905 may be fixed relative to an ultra-stable RF source. A fixed laser repetition rate results from stabilizing the cavity length. The cavity length may be stabilized via a feedback process using phase-locked loop (PLL) 1005. PLL 1005 detects a small portion of the output of laser 905 by fast photodiode 1010 (rise time ˜1 ns). PLL 1005 compares the cavity repetition frequency with that of the RF source. An error signal is generated which adjusts piezo-electric transducer 1015 (PZT) on the end mirror of the cavity.

Having fixed the repetition rate, the carrier-envelop offset (CEO) may be stabilized. CEO describes the actual phase of the carrier wavelength inside the pulse envelope. For most pulsed laser applications, the group velocity (how the pulse envelope propagates) and the phase velocity (how the phase of the spectral components propagate) are different. This difference results in a “slip” in the carrier phase within the pulse envelope and limits the temporal coherence of laser 905. In an embodiment, locking the CEO permits measurement of scattered beam 130 using pulse n₀ 205 and pulse n₀+n 210.

CEO may be stabilized using, e.g., f-to-2f interferometry, which requires laser 905 to have at least an octave of spectral width. In particular, PCF 1020 samples a fraction of the output of laser 905, which generates a supercontinuum spectrum. Next, a portion of the supercontinuum may be frequency doubled and heterodyned with the remaining supercontinuum. By selecting only wavelengths which are present in both spectra via a bandpass filter, a heterodyne signal is created which describes the CEO. This signal may be stabilized against a second RF source or an atomic standard, such as a Cs clock, in a similar matter as with PLL 1005. The generated error signal is, in turn, is provided as feedback to the current control on laser 905. By changing the current to laser 905, the CEO can be varied. Accordingly, source 105 has long-term stability in excess of 100 seconds, which exceeds the stability require for the receiver.

FIGS. 11A and 11C show the correspondence between the time and frequency domain, respectively, for a conventional pulse train. In particular, FIG. 11A shows the carrier-envelope, and FIG. 11C shows the frequency comb of the pulse train. Further, FIG. 11B shows the conventional pulse train comprising pulses having different phases, thus destroying the temporal coherence between the pulses in the train. Temporal stabilization of the pulse-repetition rate and carrier-envelop reduces the linewidth of each frequency to sub-hertz values. As a result, the coherence length of the laser can be extended since the coherence length is determined by the linewidth of the individual frequency components.

FIG. 12 shows an exemplary pulse having a broad multispectral supercontinuum which can be generated, for example, by UWB source 910.

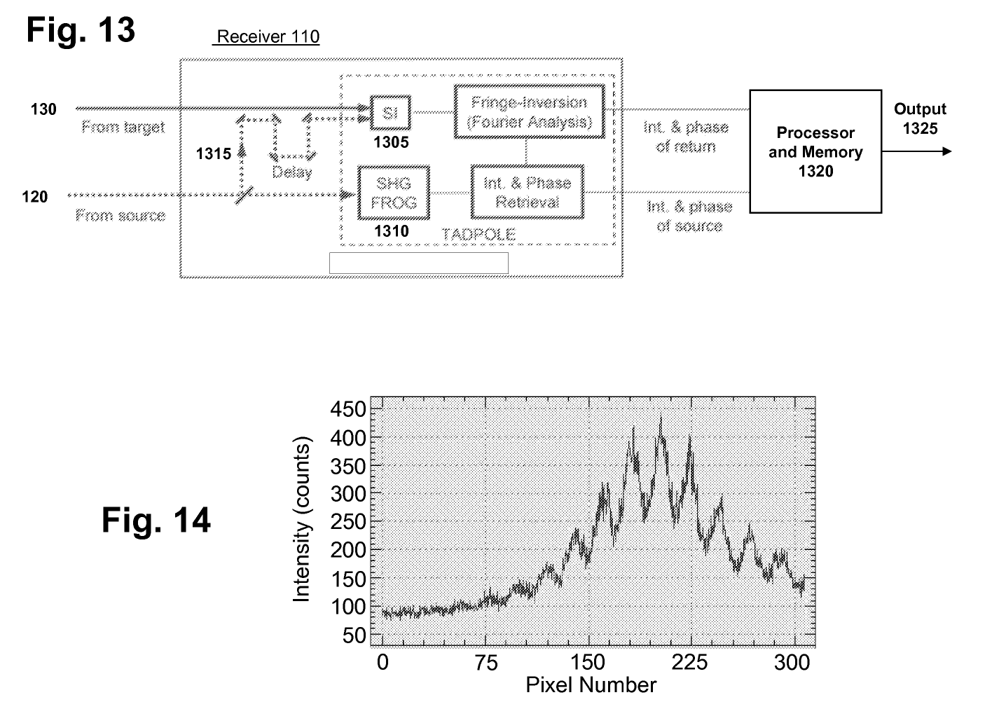

FIG. 13 shows a highly sensitive receiver 110 based on an optical retrieval process which greatly reduces the required return energy in the scattered beam 130. Receiver 110 combines frequency resolved optical gating (FROG) 1310 with spectral interferometry (SI) 1305 in a technique called TADPOLE (Temporal Analysis by Dispersing a Pair of Light E-fields). Further, receiver 110 can also implement POLLIWOG (POLarization Labeled Interference versus Wavelength of Only a Glint), a modification of TADPOLE, which enables recovery of polarization information from pulses 130. See, e.g., U.S. Pat. Nos. 5,530,544 and 5,936,732, herein incorporated by reference.

Scattered pulses 130 and reference pulse 120 collinearly propagate toward SI device 1305. The spectrum of the resulting interference pattern between scattered pulses 130 and reference pulse 120 is measured using a spectrometer. The signal from the spectrometer, called an interferogram, comprises a fringe pattern which varies as a function of wavelength. Since the interference process requires temporal overlap of both pulse 120 and 130, delay 1315 is provided to ensure that pulses 120 and 130 arrive simultaneously at SI device 1305. In an embodiment, two different pulses 120 and 130 separated by a time delay can be caused to interfere, thus enabling the detection of distant target 125. Delay 1315 is different than conventional delay lines selected based upon the target range, as discussed above. In particular, delay 1315 is selected to align scattered pulses 130 with a subsequent reference pulse 120, and is not based on time-of-flight of a pulse or target distance. In an embodiment, delay 1315 may provide a delay less than or equal to the period of train of pulses.

To acquire the optical information of scattered pulses 130, laser source 105 can be initially characterized. Standard FROG device 1310 performs the initial characterization of source 105 using reference pulses 120, and provides the amplitude and phase information specific to laser source 105. Once the optical information of source 105 is known, receiver 110 can decode the fringe pattern in the interferogram in order to retrieve the optical information of scattered pulses 130. It is not necessary, however, to perform the initial characterization on each pulse exiting laser 105 since the retrieved optical information describing laser source 105 is valid for extended time periods due to the long term stability and coherence time of source 105. Accordingly, the optical information in scattered beam 130 can be retrieved. Further, by reducing pulse energy requirements, source 105 can be simply an oscillator or an oscillator with a small amplification stage. As a result, source 105 does not require the additional complexity of high power amplification techniques, e.g., a chirp pulsed amplifier.

Processor and memory 1320 may determine a target signature based on the intensity and phase of scattered pulses 130. Further, processor and memory 1320 can be configured to compare the target signature to a database of target signatures, thus enabling target 125 to be classified and/or identified.

FIG. 14 shows experimental results of an interferogram from the temporal overlap of two time delayed pulses, i.e., the n^{th} and n^{th}+4 pulses. For this example, the laser transmitter was both repetition-rate and CEO stabilized. The time delay of four pulses corresponds to 50 ns (i.e., a distance of 15 m) since the laser source 105 runs at 80 MHz. The fringe contrast in FIG. 14 is excellent with modulation depth of 50%. This fringe contrast verifies that these pulse are mutually coherent, and thus confirms the suitability of using time delayed pulses for long range surveillance and reconnaissance.

While particular embodiments of this disclosure have been described, it is understood that modifications will be apparent to those skilled in the art without departing from the spirit of the inventive concept. The scope of the inventive concept is not limited to the specific embodiments described herein. Other embodiments, uses, and advantages will be apparent to those skilled in art from the specification and the practice of the claimed invention.

We claim:

1. A receiver configured to detect ultrashort multispectral pulses of radiation scattered by a target, the receiver comprising:
a detector configured to detect scattered radiation pulses produced by scattering of emitted radiation pulses by the target;
an interferometer configured to interfere the scattered pulses with reference pulses, wherein the emitted pulses and the reference pulse are different radiation pulses in a series of pulses; and
a processor configured to determine an intensity and a phase of the scattered pulses based on the interference of the scattered pulses with the reference pulses.

2. The receiver of claim 1, further comprising a delay configured to delay the reference pulses by less than or equal to a period of the series of pulses, wherein the delayed reference pulses are interfered with the scattered pulses.

3. The receiver of claim 1, wherein the emitted pulses are polarized, and the processor is further configured to detect polarization information contained within the scattered pulses.

4. The receiver of claim 1, wherein the emitted pulses are shaped by a pulse shaping encoder.

5. The receiver of claim 1, wherein the processor is further configured to determine a target signature based on the intensity and phase of the scattered pulses.

6. A method of detecting ultrashort multispectral pulses of radiation scattered by a target, the method comprising:
generating a series of coherent radiation pulses;
emitting radiation pulses from the series of pulses, wherein the references pulses and the emitted pulses are different pulses;
receiving scattered radiation pulses produced by scattering of the emitted pulses by the target;
interfering the scattered pulses with the reference pulses; and
determining an intensity and a phase of the scattered pulses based on the interference.

7. The method of claim 6, further comprising delaying the reference pulses by less than or equal to a period of the series of pulses before interfering the scattered pulses with the reference pulses.

8. The method of claim 6, wherein the emitted pulses are ultra-wideband laser pulses of radiation.

9. The method of claim 6, further comprising detecting polarization information contained within the scattered pulses.

10. The method of claim 6, wherein the emitted pulses are shaped by a pulse shaping encoder.

11. The method of claim 6, further comprising determining a target signature based on the intensity and phase of the scattered pulses.

12. A system configured to emit and receive ultrashort multispectral pulses of radiation, the system comprising:
a source configured to generate a series of radiation pulses including reference radiation pulses and emitted radiation pulses;
a receiver configured to receive scattered radiation pulses produced by scattering of the emitted radiation pulses by a target;
an interferometer configured to interfere the scattered pulses with reference pulses; and
a processor configured to determine an intensity and a phase of the scattered pulses based on an output of the interferometer.

13. The system of claim 12, further comprising a delay configured to delay the reference pulses by less than or equal to a period of the series of pulses, wherein the delayed reference pulses are interfered with the scattered pulses.

14. The system of claim 12, wherein the emitted radiation pulses are ultra-wideband laser pulses.

15. The system of claim 12, the source comprising a stability circuit that stabilizes a pulse-repetition rate of the series of radiation pulses.

16. The system of claim 12, wherein the emitted radiation pulses are polarized, and the processor is further configured to detect polarization information contained within the scattered pulses.

17. The system of claim 12, wherein the emitted radiation pulses are shaped by a pulse shaping encoder.

18. The system of claim 12, wherein the processor is further configured to determine a target signature based on the intensity and phase of the scattered pulses.

19. The system of claim 18, wherein the processor is further configured to compare the target signature to a database of target signatures.
